(19) United States
(12) Patent Application Publication
(10) Pub. No.: US 2026/0078887 A1
(43) Pub. Date: Mar. 19, 2026

(54) ILLUMINATING DISPLAY APPARATUS

(71) Applicant: LH Helmets, LLC, Boerne, TX (US)

(72) Inventors: Jordan Eubanks, Boerne, TX (US); Joshua Hoffman, Boerne, TX (US)

(73) Assignee: LH Helmets, LLC, Boerne, TX (US)

(21) Appl. No.: 19/329,548

(22) Filed: Sep. 15, 2025

Related U.S. Application Data
(60) Provisional application No. 63/695,246, filed on Sep. 16, 2024.

(51) Int. Cl. F21V 3/02; F21Y 107/50; F21Y 113/00; F21Y 115/10

(52) U.S. Cl. CPC F21V 3/02; F21Y 2107/50; F21Y 2113/00; F21Y 2115/10

(57) ABSTRACT

An illuminating display apparatus includes an outer shell having an outer surface, an inner surface, and an interior cavity. The shell is made of a translucent material, and the outer surface consists of a first area and a second area. An opaque layer is applied to the first area and a translucent layer is applied to the second area. A light apparatus includes a support structure having a primary surface and a plurality of secondary surfaces. The secondary surfaces are oriented at different angles relative to the primary surface, and the support structure is positioned within the interior cavity. A plurality of light sources are distributed across the primary surface and the plurality of secondary surfaces. The light sources on the secondary surfaces are oriented to direct light towards secondary interior portions and the light sources on the primary surface are oriented to direct light towards a primary interior portion.

### CROSS-REFERENCE TO RELATED APPLICATIONS

This Application claims priority to U.S. Provisional Ser. No. 63/695,246 filed on Sep. 16, 2024, entitled “Illuminating Display Apparatus,” the contents of which are incorporated herein by reference.

### BACKGROUND

### Field of the Art

The present disclosure is related to the field of illuminated displays. In particular, the present disclosure is related to sports memorabilia illuminated displays, such as helmets that are for display purposes.

### Discussion of the State of the Art

The collectible helmet market has grown significantly over the years, with enthusiasts and collectors seeking unique and innovative designs. These helmets, often featuring licensed logos of sports teams, movie franchises, or other popular culture icons, serve as a form of expression and a way to demonstrate allegiance or fandom. However, the current designs available in the market are static and lack a dynamic visual element that could enhance their appeal.

One area that has been largely unexplored in the collectible helmet market is the incorporation of illumination features. The use of light can add a visually striking element, enhancing the aesthetic appeal of the helmet and allowing for a more engaging display. This could potentially increase the value and desirability of these collectible items.

Despite the potential benefits, no company has successfully integrated an illumination feature into an actual helmet. Some have attempted to incorporate light into helmet designs, but these efforts have resulted in products that are far removed from the traditional helmet form factor. For instance, some companies have produced 2D plastic helmets with illumination features. However, these products lack the depth and realism of a 3D helmet, diminishing their appeal to collectors who value authenticity.

In addition, the use of entirely different products to incorporate illumination, such as light stands or display cases, has been attempted. However, these solutions are external to the helmet itself and do not enhance the helmet's intrinsic design. They also add to the overall cost and require additional space for display, which may not be desirable or feasible for many collectors.

In summary, there is a clear gap in the market for a collectible helmet that incorporates an illumination feature in a way that enhances the design without compromising the authenticity of the helmet. Existing attempts to fill this gap have resulted in products that either deviate too far from the traditional helmet form factor or require additional external components, both of which are suboptimal solutions.

### SUMMARY

The present invention offers a significant advancement in the collectible helmet market by integrating a dynamic illumination feature into the helmet design. This invention encompasses a decorative and ornamental helmet that includes an outer shell and a light source positioned inside the outer shell. The outer shell has a unique design and silhouette, and is adorned with translucent stickers or decals. The portions of the outer shell that are not covered with the decals are covered with an opaque layer. The light source is configured to provide uniform light distribution, and the light emitted by the light source passes through the translucent decals and is blocked by the opaque layer. The innovative design creates a captivating visual effect as the lights shine through the licensed logos on the decals.

In one example, the present invention is an illuminating display apparatus that includes an outer shell having an outer surface, an inner surface, and an interior cavity surrounded by the inner surface. The outer shell is made of a translucent material for dispersing light, and the outer surface consists of a first area and a second area. The interior cavity comprises a primary interior portion and a plurality of secondary interior portions. An opaque layer is applied to the first area of the outer surface, and a translucent layer is applied to the second area of the outer surface. The opaque layer may include opaque paint. The translucent layer may include a translucent decal. The translucent material of the outer shell may be a white plastic material. The translucent material of the outer shell may be polycarbonate having uniform translucency throughout the outer shell. A face mask, a visor, and/or a bumper may be attached to the outer surface of the outer shell.

The display apparatus further includes a light apparatus that includes a support structure having a primary surface and a plurality of secondary surfaces. The primary surface may be a planar surface. The secondary surfaces are oriented at different angles relative to the primary surface. The support structure is positioned within the interior cavity with the primary surface oriented substantially parallel to the primary interior portion. The light apparatus further includes a plurality of light sources distributed across the primary surface and the plurality of secondary surfaces on the support structure. The light sources on the plurality of secondary surfaces are oriented to primarily direct light towards the secondary interior portions, and the light sources on the primary surface are oriented to direct light primarily towards the primary interior portion. The plurality of light sources may be a plurality of LEDs. The outer shell may include a lower opening, and the light apparatus may be positioned in the lower opening and attached to the outer shell around a lower periphery that defines the lower opening. The display apparatus may further include a light dispersing cover disposed between the support structure and the inner surface of the outer shell. The light dispersing cover may be configured for evenly dispersing light emitted by the plurality of light sources throughout the interior cavity.

In another example, the present invention is a method of manufacturing an illuminating display apparatus. The method includes providing an outer shell made of a translucent material that scatters light. The outer shell has an outer surface, an inner surface, and an interior cavity. The method further includes applying a translucent decal to the outer surface. The decal has an adhesive surface that is applied directly to the outer surface of the outer shell and an opposite surface covered with a transfer tape. The method further includes applying opaque paint to the entire outer surface of the outer shell, and removing the transfer tape from the translucent decal. Removing the transfer tape further removes a portion of the opaque paint, such that the outer surface consists of a first area covered in opaque paint and a second area covered by the translucent decal. The method further includes positioning a light apparatus within the interior cavity. Light emitted by the light apparatus is transmitted from the interior cavity and emanates through the translucent decal but not through the opaque paint. After applying the translucent decal and before applying the opaque paint, an adhesion promoter may be applied to the outer surface of the outer shell. After applying the adhesion promoter and before applying the opaque paint, a primer may be applied to the outer surface of the outer shell. After applying the opaque paint, a clear top coat may be applied to the entire outer surface of the outer shell. The step of applying the clear top coat may be performed after the step of removing the transfer tape. The step of applying the opaque paint may include applying two or more coats of the opaque paint.

The illuminating display apparatus in accordance with the present invention successfully addresses the limitations of previous solutions by adding a dynamic and visually appealing feature to the static design of collectible helmets. The integration of illumination enhances not only the aesthetic appeal but also the overall value of these collectible items.

The illuminating display apparatus is adaptable to a variety of helmet types and novelty shapes, including football helmets, baseball helmets, NASCAR® helmets, Formula 1® helmets, hockey goalie masks, and other custom designs. This versatility further increases its appeal to a broad range of collectors and fans.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIGS. 1A and 1B are perspective and exploded views, respectively of an illuminating display apparatus, in accordance with an aspect of the present invention.

FIG. 1C is a perspective view of a light source for the illuminating display apparatus depicted in FIGS. 1A and 1B, in accordance with an aspect of the present invention.

FIG. 2A is an exploded view of an illuminating display apparatus, in accordance with an aspect of the present invention.

FIG. 2B is a perspective view of a light source for the illuminating display apparatus depicted in FIG. 2A, in accordance with an aspect of the present invention.

FIGS. 3A-3C illustrate steps in a method of manufacturing an illuminating display apparatus, in accordance with aspects of the present invention.

FIG. 4 is a flow chart of a method of manufacturing an illuminating display apparatus, in accordance with an aspect of the present invention.

FIG. 5A is a cross-sectional view of an illuminating display apparatus, in accordance with an aspect of the present invention.

FIG. 5B is a magnified view of layers applied to an outer surface of an outer shell of the illuminating display apparatus depicted in FIG. 5A, in accordance with an aspect of the present invention.

FIG. 5C is a cross-sectional view of an illuminating display apparatus having a light dispersing cover over a light source, in accordance with an aspect of the present invention.

### DETAILED DESCRIPTION

The present invention is for an illuminated display having a translucent outer shell, a light source positioned within the outer shell, a layer of opaque paint applied to a first area of the outer shell, and a translucent decal applied to a second area of the outer shell. The entire outer surface of the outer shell is covered with paint or decals. The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Apparatus

The present invention is for a decorative illuminating display apparatus in the shape of a helmet or other sport memorabilia. The apparatus incorporates various components to enhance its design and functionality. For example, the apparatus includes an outer shell and a light source positioned within the outer shell. The light source is configured for illuminating the entire interior of the outer shell in a substantially uniform manner. The outer shell itself is made of a translucent material for scattering the light emitted by the light source. Translucent decals or stickers are applied to a portion of the outer surface of the outer shell. The rest of the outer surface is covered with opaque paint, such that, when the light source is turned on, light is emitted through the decals but not through the paint. In one example, the illuminating display apparatus is a football helmet and the decals are licensed logos related to a specific football team. In other examples, the illuminating display apparatus may be another type of helmet, such as a NASCAR® helmet, Formula 1® helmet, baseball helmet, hockey helmet, hockey goalie mask, or the like. In still other examples, the outer shell is shaped to resemble other types of sports memorabilia, such as jerseys, sports balls, and the like.

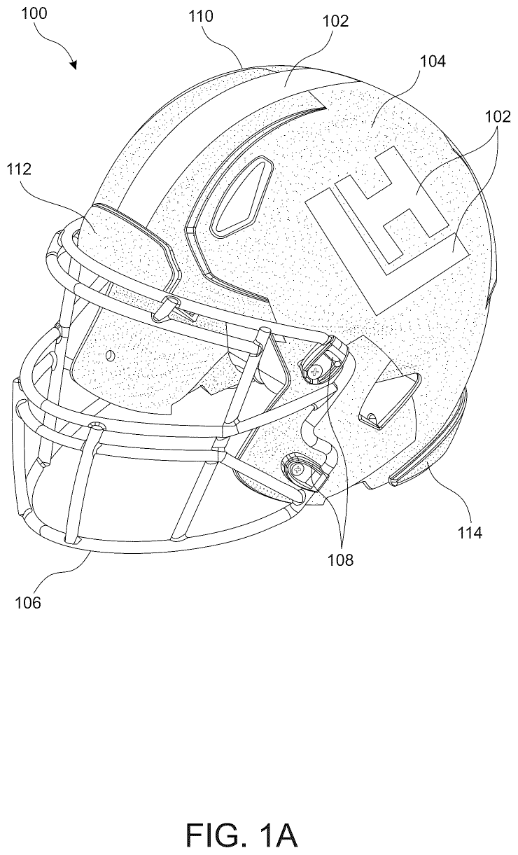

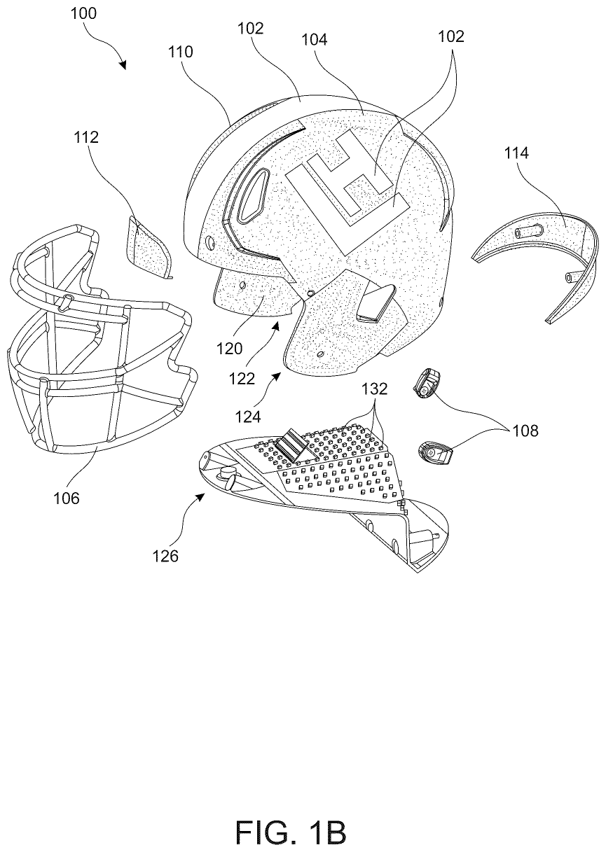

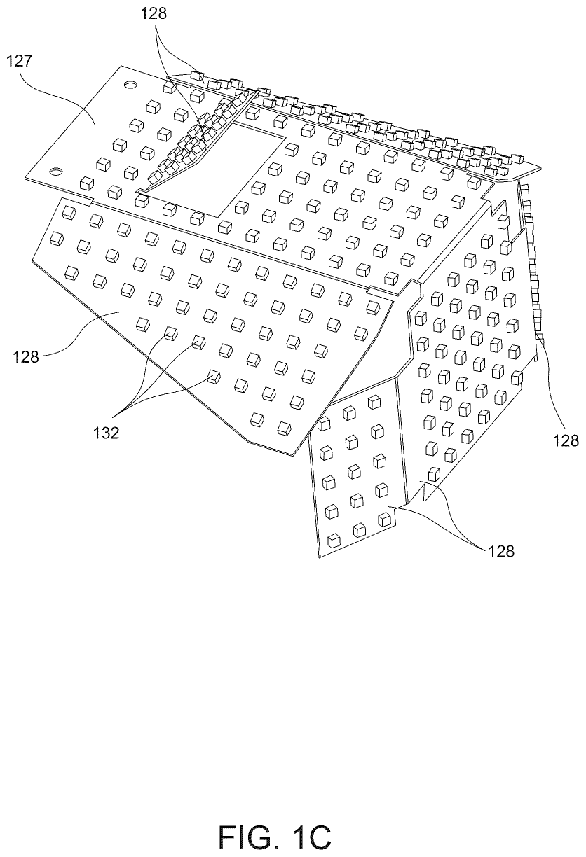

An illuminating display apparatus 100 in accordance with the present invention is depicted in FIG. 1A. In this example, the apparatus 100 is depicted as being in the shape of a football helmet. The apparatus 100 includes an outer shell 110 made of a translucent or semi-transparent material that allows scattered light to pass therethrough. The translucent or semi-transparent material of the outer shell 110 may be a white plastic material. In one example, the translucent or semi-transparent material of the outer shell 110 is a polycarbonate material that has uniform translucency throughout the outer shell 110.

The outer shell 110 has an outer surface that includes a first area 102 that is covered by a translucent or semi-transparent layer and a second area 104 that is covered by an opaque layer. The translucent areas 102 include translucent decals that allow scattered light to pass therethrough. Alternatively, the translucent areas 102 may be covered in a different type of translucent coating, such as a translucent paint. The translucent decals 102 applied to the outer surface of the outer shell 110 may be a solid color or may include two or more different colors. All of the colors are translucent, thereby allowing light to pass through the decal 102. Some colors may allow more light to pass through than others, giving the decal 102 a unique appearance where some colors appear to be more illuminated than others. The opaque areas 104 are coated in opaque paint, vinyl, or other opaque coatings that block light from passing therethrough. The opaque coating 104 applied to the rest of the outer surface of the shell 110 may be any color. The entire outer surface of the shell 110 is coated with either the opaque coating 104 or the translucent decal 102.

A light source positioned inside the outer shell 110 is configured to illuminate the entire inner surface of the outer shell 110 in a substantially uniform manner in order to avoid any bright spots or shadows that affect the uniformity of the light passing through the translucent areas 102. The apparatus 100 may further include a face mask 106 and clips 108 for attaching the facemask 106 to the outer shell 110. The apparatus 100 may further include other decorative features, such as a chin strap, front bumper 112, rear bumper 114, and/or the like.

An exploded view of the apparatus 100 is shown in FIG. 1B, which depicts the outer shell 110 having an inner surface 120 and an outer surface having an opaque area 104 and a translucent area 102. The outer shell 110 creates an interior cavity 122 having a lower opening 124. A lighting apparatus 126 is attached to the lower opening 124 of the outer shell 110. For example, the lighting apparatus 126 may be attached to the lower periphery of the shell 110. In this example, the lighting apparatus 126 includes a plurality of light sources 132. The plurality of light sources 132 may be an array of LEDs. However, the invention is not limited to the light source being an array of LEDs. In other examples, the light source may be one or more standard light bulbs, strips of fluorescent lighting, or the like. The lighting apparatus 126 creates an aesthetic underside of the display apparatus 100 and prevents the helmet from being worn by a user. In this example, the lighting apparatus 126 has a tiered configuration, but may alternatively be a flat panel or another desired shape.

The lighting apparatus 126 includes a support structure to which the plurality of light sources 132 are attached, as shown in FIG. 1C. For more even distribution of the emitted light, the support structure includes a primary surface 127 and a plurality of secondary surfaces 128 that are arranged at different angles relative to each other so that the LEDs 132 attached to the primary and secondary surfaces 127, 128 are aimed in several different directions. For example, the LEDs 132 on the primary surface 127 are oriented to direct light primarily towards a primary portion of the interior cavity 122 and the LEDs on the secondary surfaces 128 are oriented to direct light primarily towards a secondary portion of the interior cavity 122. The primary surface 127 is oriented substantially parallel to the primary portion (e.g., the crown) of the interior cavity. In this manner, the entire interior cavity 122 of the outer shell 110 may be evenly illuminated. The emitted light is scattered by the translucent material of the outer shell 110. The only light that passes through the outer shell 110 is transmitted through the translucent areas 102 covered by the decals.

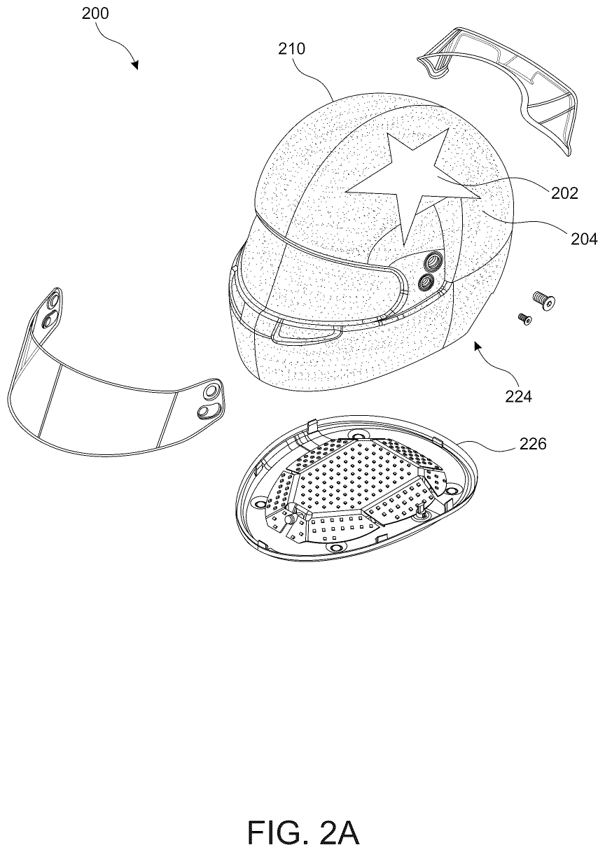

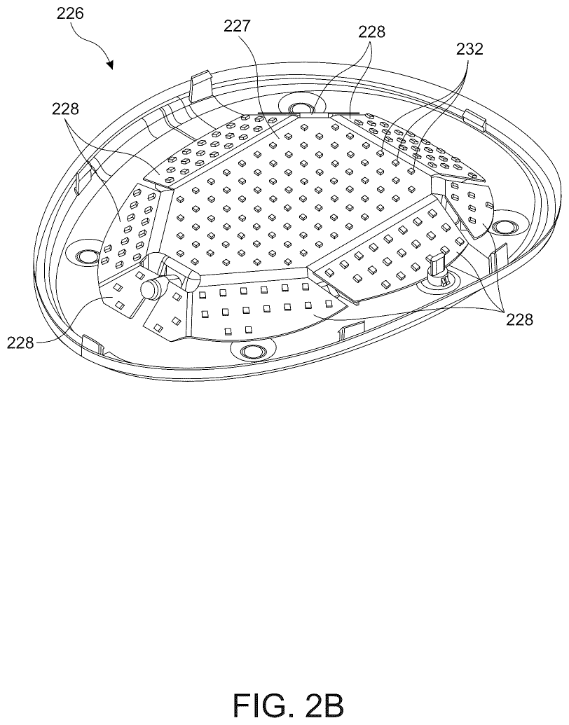

The lighting apparatus 126 may be any shape or size, depending on the shape and size of the outer shell. In another example, shown in FIGS. 2A and 2B, an illuminating display apparatus 200 is in the shape of a Formula 1® helmet and the lighting apparatus 226 of the display apparatus 200 is a different shape and size from the lighting apparatus 126 described above. The lighting apparatus 226 is relatively flat due to the size, shape, and location of the bottom opening 224 of the outer shell 210. However, as shown in FIG. 2B, the support structure of a the lighting apparatus 226 may include a primary surface 127 and a plurality of secondary surfaces 228 arranged at different angles relative to each other so that the light emitted by the LEDs 232 attached to the surfaces 227, 228 can be more evenly distributed throughout the interior of the shell 210.

The display apparatus 200 in FIG. 2A is similar to the display apparatus 100 depicted in FIGS. 1A-1C in that the apparatus 200 includes an outer shell 210 having an outer surface that includes translucent areas 202 and opaque areas 204. The outer shell 210 has a lower opening 224 that is covered by the lighting apparatus 226. The plurality of light sources 232 are oriented to illuminate the entire inner cavity of the shell 210. Light emitted by the light sources 232 passes through the translucent areas 202 on the outer surface of the shell 210.

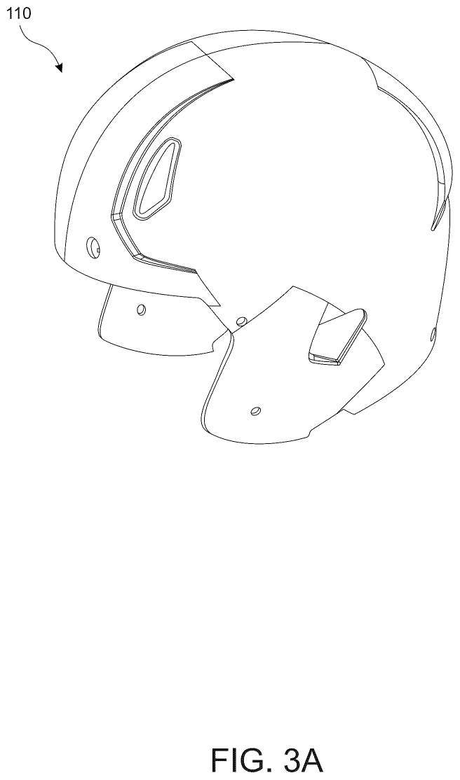

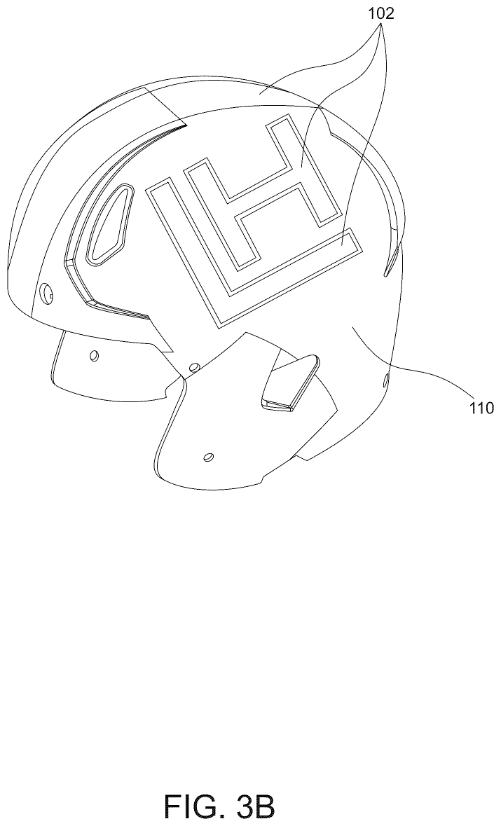

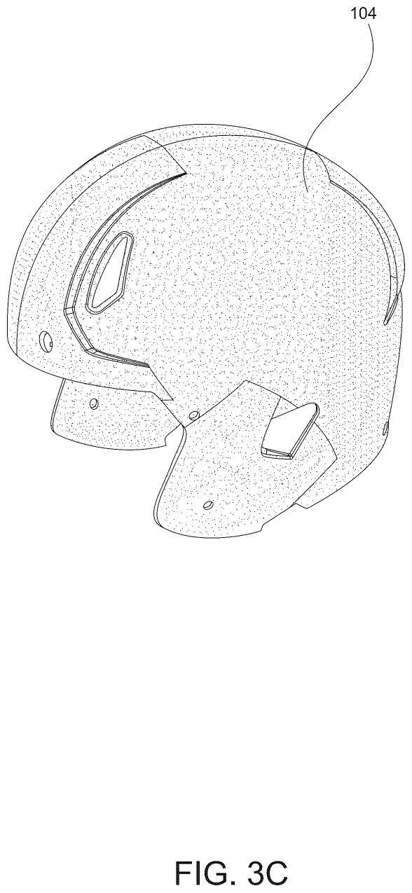

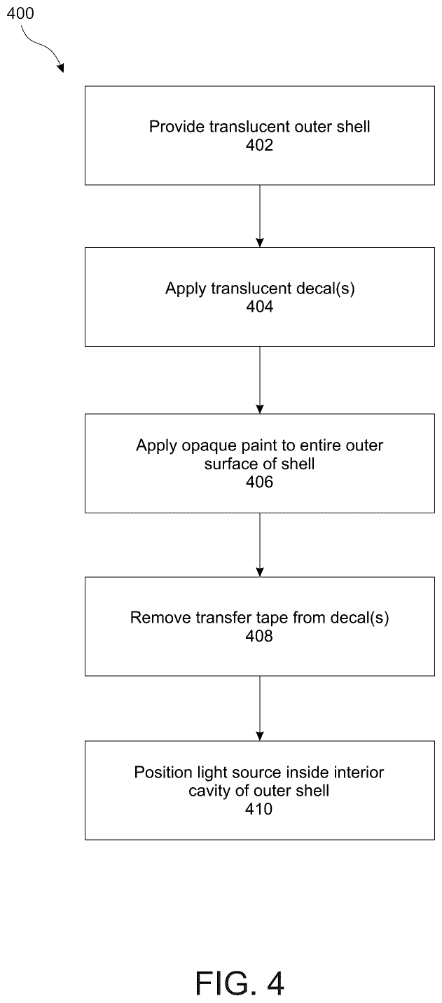

A method 400 of manufacturing the illuminating display apparatus 100 will be described with reference to FIGS. 3A-3C, 1A, and the flow chart in FIG. 4. It will be well understood by one or ordinary skill in the art that the method of manufacturing an illuminating display apparatus of any size and shape will be substantially similar to the method depicted in FIGS. 3A-4. In other words, the method 400 of manufacturing an illuminating display apparatus is not limited to a display apparatus that is in the shape of a football helmet. The method 400 of manufacturing an illuminating display apparatus may be used to manufacture a display apparatus that is in the shape of any other kind of helmet and/or any other size and shape of display apparatus.

First, in step 402, a translucent outer shell 110 is provided, as shown in FIG. 3A. The outer shell 110 may have a cloudy or milky white appearance and will be configured for allowing diffused light to pass therethrough. The outer shell 110 may be uniformly translucent. In this manner, features or items inside the outer shell 110, such as the light source and lighting panel circuity, are not visible through the shell 110, but diffuse light passes through the shell 110 in a substantially uniform manner. The light emitted by the light source and visible from outside the shell 110 will thus have a glowing effect.

Next, in step 404, translucent decals or stickers 102 are applied to the outer surface of the shell 110, as shown in FIG. 3B. In particular, the translucent decals 102 may have an adhesive surface that directly contacts the outer surface of the shell 110 so that the translucent decal 102 is fixedly applied to the outer surface of the shell 110. The translucent decal 102 may have a solid color or may have a design that includes two or more colors. Darker colors in the decal 102 may allow less light to pass therethrough, while lighter colors will allow more light to pass therethrough. In other words, the decal 102 may not be uniformly translucent due to varying amounts of pigmentation in the decal 102. One or more decals 102 may be attached to the outer surface of the shell 110. For example, decals 102 may be attached to the sides of the shell 110, down the middle of the shell 110, in the front of the shell 110, and/or the like. The translucent decals 102 further include a transfer tape on the outer surface thereof. That is, the translucent decals 102 include an adhesive surface and an opposite surface having a transfer tape attached thereto.

Next, in step 406, one or more opaque coatings 104 are applied to the outer shell 110, as shown in FIG. 3C. For example, opaque paint is applied to the entire outer surface of the shell 110. Additional coatings may also be applied to the outer surface. For example, adhesion promoter, base coat, primer, additional layers of opaque paint, and/or top coat may be applied to the entire outer surface of the shell 110. In one example, a layer of adhesion promoter and a layer of primer are applied to the outer shell 110 before the opaque paint is applied. Two or more layers of opaque paint may be applied to the outer shell 110.

Next, in step 408, after the opaque coatings are dried and cured, the transfer tape is removed from the decal 102 in order to expose the decal 102 and remove any opaque coatings or top coatings that were applied to the entire outer surface including the transfer tape. After the transfer tape is removed from the decals, the apparatus 100 will appear as shown in FIGS. 1A and 1B with the outer surface of the shell 110 having opaque areas 104 and translucent areas 102. Optionally, before and/or after the transfer tape is removed, a top coat of clear paint or clear lacquer may be applied to the entire outer surface of the shell 110.

Finally, in step 410, a light source is positioned inside the interior cavity of the shell 110. When the light source is turned on so that light is emitted by the light source, the emitted light shines through the transparent areas 102 applied to the outer surface of the shell 110.

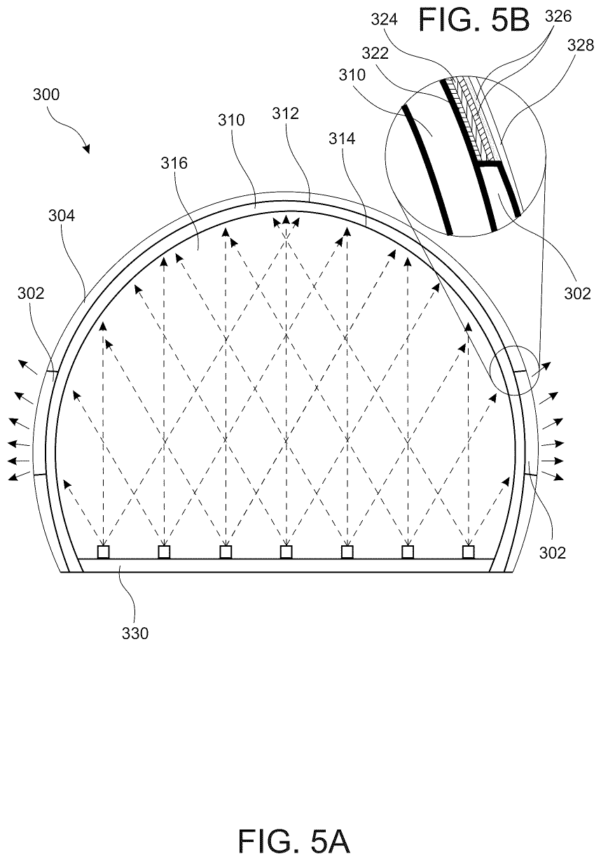

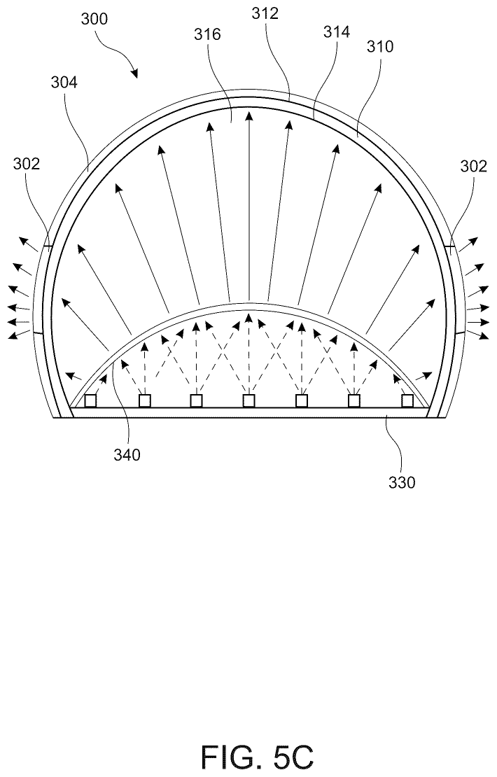

A cross-sectional view of an illuminating display apparatus 300 is depicted in FIG. 5A. The display apparatus 300 includes an outer shell 310 made of a translucent material. The outer shell 310 includes an outer surface 312, an inner surface 314 and an interior cavity 316. Translucent decals 302 are applied to the outer surface 312. The rest of the outer surface 312 is covered by an opaque coating 304. The apparatus 300 further includes a light apparatus 330 that illuminates the entire inner cavity 316 of the shell 310 in a substantially uniform manner.

As shown in the magnified view of FIG. 5B, the opaque coating 304 may include a plurality of layers. In the example shown in FIG. 5B, the opaque coating 304 may include an adhesion promoter layer 322, a primer or base coat layer 324, and two layers of opaque paint 326. Alternatively, the opaque coating 304 may include only a single coat of opaque paint or may include three or more coats of opaque paint. A clear top coat 328 may be applied to the entire outer surface 312 of the shell 310. Alternatively or additionally, the clear top coat 328 may be applied before the transfer tape is removed from the decals 302, in which case the clear top coat 328 would be applied to the opaque areas 304, but not to the translucent areas 302.

In another example, shown in FIG. 5C, the illuminating display apparatus 300 includes a diffusion cover 340 positioned inside the shell 310 between the inner surface 314 of the shell and the light apparatus 330. The light dispersing cover 340 functions to further disperse the light emitted by the light apparatus 330 to ensure that the emitted light is scattered uniformly throughout the interior cavity 316.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present) , and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. An illuminating display apparatus comprising:
an outer shell comprising an outer surface, an inner surface, and an interior cavity surrounded by the inner surface, wherein the outer shell is made of a translucent material for dispersing light, wherein the outer surface consists of a first area and a second area, and wherein the interior cavity comprises a primary interior portion and a plurality of secondary interior portions;
an opaque layer applied to the first area of the outer surface;
a translucent layer applied to the second area of the outer surface; and
a light apparatus comprising:
a support structure having a primary surface and a plurality of secondary surfaces, wherein the secondary surfaces are oriented at different angles relative to the primary surface, and wherein the support structure is positioned within the interior cavity with the primary surface oriented substantially parallel to the primary interior portion; and
a plurality of light sources distributed across the primary surface and the plurality of secondary surfaces on the support structure,
wherein the light sources on the plurality of secondary surfaces are oriented to primarily direct light towards the secondary interior portions, and wherein the light sources on the primary surface are oriented to direct light primarily towards the primary interior portion.

2. The illuminating display apparatus of claim 1, wherein the opaque layer comprises opaque paint.

3. The illuminating display apparatus of claim 1, wherein the translucent layer comprises a translucent decal.

4. The illuminating display apparatus of claim 1, wherein the plurality of light sources comprises a plurality of LEDs.

5. The illuminating display apparatus of claim 1, wherein the outer shell comprises a lower opening, and wherein the light apparatus is positioned in the lower opening and attached to the outer shell around a lower periphery that defines the lower opening.

6. The illuminating display apparatus of claim 1, wherein the primary surface is a planar surface.

7. The illuminating display apparatus of claim 1, further comprising a light dispersing cover disposed between the support structure and the inner surface of the outer shell, the light dispersing cover configured for evenly dispersing light emitted by the plurality of light sources throughout the interior cavity.

8. The illuminating display apparatus of claim 1, wherein the translucent material of the outer shell is a white plastic material.

9. The illuminating display apparatus of claim 1, wherein the translucent material of the outer shell is polycarbonate having uniform translucency throughout the outer shell.

10. The illuminating display apparatus of claim 1, further comprising at least one of: a face mask, a visor, and a bumper attached to the outer surface of the outer shell.

11. A method of manufacturing an illuminating display apparatus comprising:
providing an outer shell made of a translucent material that scatters light, the outer shell having an outer surface, an inner surface, and an interior cavity;
applying a translucent decal to the outer surface, the decal having an adhesive surface that is applied directly to the outer surface of the outer shell and an opposite surface covered with a transfer tape;
applying opaque paint to the entire outer surface of the outer shell;
removing the transfer tape from the translucent decal, wherein removing the transfer tape further removes a portion of the opaque paint, such that the outer surface consists of a first area covered in opaque paint and a second area covered by the translucent decal; and
positioning a light apparatus within the interior cavity, wherein light emitted by the light apparatus is transmitted from the interior cavity and emanates through the translucent decal but not through the opaque paint.

12. The method of claim 11, further comprising, after applying the translucent decal and before applying the opaque paint, applying an adhesion promoter to the outer surface of the outer shell.

13. The method of claim 12, further comprising, after applying the adhesion promoter and before applying the opaque paint, applying a primer to the outer surface of the outer shell.

14. The method of claim 11, further comprising, after applying the opaque paint, applying a clear top coat to the entire outer surface of the outer shell.

15. The method of claim 14, wherein the step of applying the clear top coat is performed after the step of removing the transfer tape.

16. The method of claim 11, wherein the step of applying the opaque paint comprises applying two or more coats of the opaque paint.
